(19) United States
(12) Patent Application Publication
(10) Pub. No.: US 2007/0110225 A1
(43) Pub. Date: May 17, 2007

(54) Method and apparatus for efficient encryption

(75) Inventors: David H. Leventhal, Tucson, AZ (US); William M. Birdsall, Tucson, AZ (US); Edward H. Currie, Beechhurst, NY (US)

Correspondence Address: MACPHERSON KWOK CHEN & HEID LLP, 2033 GATEWAY PLACE, SUITE 400, SAN JOSE, CA, 95110, US

(73) Assignee: Sub-Crypto Systems, LLC

(21) Appl. No.: 11/281,138

(22) Filed: Nov. 16, 2005

(51) Int. Cl. H04L 9/28; H04L 9/00; H04L 9/30; H04K 1/00; H04K 1/06; H04K 1/04

(52) U.S. Cl. 380/28; 380/30; 380/29; 380/37

(57) ABSTRACT

Methods and apparatuses are provided for accelerating the throughput and or reducing the power consumption of symmetric cryptography algorithms. Certain computations of a symmetric encryption or decryption algorithm are performed during a first phase, the results are saved to memory, and the results are retrieved to encode data during a second phase. If the first phase is implemented while the battery is being charged and the second phase is implemented while the system runs on battery power, the battery life is significantly extended compared to the battery life when all phases are implemented using solely battery power.

### FIELD OF THE INVENTION

This invention relates to the encryption and decryption of digital data.

### BACKGROUND OF THE INVENTION

Today's information systems feature large storage capacity and network bandwidth. This has increased the need for secured transmission and storage of digital data. Cryptographic techniques including the use of symmetric algorithms have been developed for this purpose. In a symmetric algorithm, two or more parties of a secure channel use a shared private key to encrypt and decrypt data sent and received over the channel. There are many symmetric encryption algorithms in use today, including Advanced Encryption Standard (AES), and its predecessors Data Encryption Standard (DES) and Triple-DES. For the specification of AES, see Federal Information Processing Standards (FIPS) Publication 197, “Advanced Encryption Standard,” the contents of which are herein incorporated by reference.

One challenge in implementing such cryptographic techniques in general is the great computational power needed to perform encryption and decryption, as measured by the number of required clock cycles. Using conventional microprocessor technology, AES requires approximately 320 clock cycles to encode a 16-byte block, whereas DES requires as many as 668 clock cycles (1728 clock cycles in Triple-DES). The number of clock cycles directly affects the power consumption and available processor speed of a device. Power consumption is critical for mobile devices, such as cell phones or personal digital assistants (PDA's), that operate with a limited power source. Available processor speed is important in high-speed applications such as high-end servers and high-speed routers, which typically have limited processing resources due to demanding application requirements.

Speed and power consumption of encryption algorithms are also important in military applications. High bandwidth sensor networks, or video surveillance systems, have a typical transmission rate of 35-40 Mbps due to the combination of high definition video, audio, and control signals. When capturing, transmitting, or recording video data in a military intelligence environment, quality of service is of utmost importance. The signals from surveillance videos receive only a cursory examination in the field. The real work is done back in a lab where the video signals are carefully reviewed with the aid of computer enhancement. It is not reasonable for an embedded class processor to perform the computation necessary to provide secure communication while operating in the field under severe power constraints. Another concern in the military is the total thermal signature of a device in low light conditions. Thermal night vision is often able to detect mobile devices with a large thermal signature, so minimizing the thermal signature is of great importance.

As described, the issue of computational resources affects all classes of computing systems. Because of their demanding computational requirements, encryption algorithms for high-performance or low-power environments have traditionally been implemented in dedicated hardware. Changing such algorithms thus entails modifying hardware, which is relatively costly compared to modifying software code.

Much of the effort to reduce the number of clock cycles in video recording and transmission has been focused on selective frame encryption. In this scheme, certain frames or other units of a transmission are selected for encryption, while other frames or units are not encrypted, thus decreasing the amount of actual data to be encrypted. While selective frame encryption saves clock cycles, the scheme is problematic in that it may not be truly secure, as significant portions of data may be left unencrypted.

It is thus desirable to have a method of robustly encrypting and decrypting data that efficiently utilizes the scarce power and bandwidth resources in today's mobile, high-performance, and military systems.

Another problem in networks using symmetric encryption algorithms is that system security may be compromised if one of the nodes is breached, since all nodes in the network share the same key. In a conventional system, the only way to address such a breach would be to change the keys of all the devices. It would thus also be desirable to have a symmetric encryption system wherein breaching the security of one node would not necessarily compromise the security of all nodes.

### SUMMARY OF THE INVENTION

The invention provides methods and apparatuses for accelerating the throughput of and or reducing the power consumption of cryptography algorithms by reducing the number of processor clock cycles required during critical operation. This is accomplished by performing computation-intensive cryptographic operations during periods of time when computational resources are more abundant, while minimizing the computations performed during periods of time when resources are less abundant. In a mobile device, these periods may correspond respectively to when the device is being powered by a battery charger, and when the device is being powered by a battery.

The theoretical basis for the invention rests on three observations:
1) With some cryptographic algorithms, it is possible to perform certain demanding computations independently of the data to be encrypted or decrypted, and store the results of those computations for retrieval at a later time.
2) The cost of storing computation for later retrieval is relatively low due to the availability of relatively power-efficient and inexpensive memory components, such as FLASH memory.
3) The marginal cost of power and computation is lower when there are more abundant resources for power and computation.

For example, a mobile device according to the present invention operates according to two distinct phases. During Phase I, the device is powered by a battery charger. During this phase, the CPU is operated using the power available from the battery charger, which is relatively inexpensive, to perform the computationally intensive cryptographic operations. The results of these computations are written to secondary storage. During Phase II, the device can be operating on battery power. During this phase, the results of Phase I are retrieved from secondary storage and used to encrypt or decrypt the data, typically by applying a simple XOR operation.

By partitioning the computation into these two phases, the algorithm utilizes the charger power to perform the more intensive computations, thus sparing the battery from having to power those same computations later when the charger is unplugged. Pre-computing and storing the results in memory trades hardware (available memory) for time, since fewer computations are performed during battery-powered operation. As a result, the present invention can perform AES encryption with 64 times fewer clock cycles and Triple DES with 345 times fewer clock cycles during battery-powered operation than a conventional system. This increases battery life by drawing less power during battery-powered operation.

### BRIEF DESCRIPTION OF THE DRAWINGS

The accompanying drawings illustrate embodiments of the invention and, together with the description, serve to explain the principles of the invention. The applications disclosed are for illustrative purposes only, and are not meant to restrict the scope of the present invention. Embodiments in accordance with the present invention are relevant to all types of data.

FIG. 1A is a schematic of the apparatus in charging phase (Phase I).

FIG.1B is a schematic of the apparatus in operating phase (Phase II).

FIG.2 is a schematic of the apparatus demonstrating the method of reduced processor utilization and the consequent reduction in power consumption and size of thermal signature.

FIG.3 is a schematic of the apparatus demonstrating the method of accelerating of data throughput when encrypting and decrypting.

FIG.4 is a schematic of the apparatus demonstrating the method of reduced memory requirements.

FIG.5 is a schematic of the apparatus demonstrating the method of not storing a private key as a result of using the present invention.

FIG.6 is a schematic of the apparatus demonstrating the method of handling a data burst.

FIG.7 is a schematic of the apparatus demonstrating the method of video transmission over wireless.

FIG.8 is a schematic of the apparatus demonstrating the method of video recording or playback.

FIG.9 is a schematic of the apparatus demonstrating the method of a mobile video data server.

FIG.10 shows the methods and apparatus being used in a sensor network configuration.

FIG.11 shows the methods and apparatus being used in a mobile network configuration.

FIG.12 shows the methods and apparatus being used in a mobile storage configuration.

FIG.13 shows the methods and apparatus being used in a high-end server configuration.

FIG.14 shows the methods and apparatus being used in a high-speed router configuration.

FIG. 14A shows the methods and apparatus being used in a high-speed router and high-end database server configuration.

FIG.15 shows the methods and apparatus being used to support high-end server logging.

FIG. 16 shows a 128-bit block cipher counter-mode encryption scheme for encrypting a single 128-bit block of plaintext.

FIG. 17A shows the operations that are performed in Phase I according to the present invention.

FIG. 17B shows the operations that are performed in Phase II according to the present invention.

### DETAILED DESCRIPTION OF THE PREFERED EMBODIMENTS

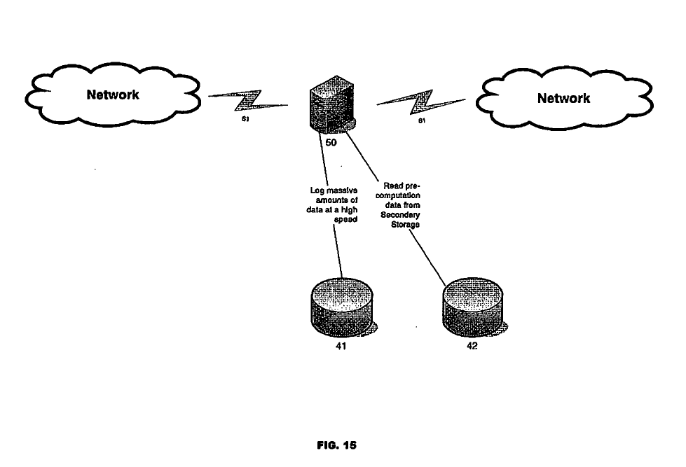

FIG. 16 shows a 128-bit block cipher counter-mode (CTR) encryption scheme for encrypting a single 128-bit block of plaintext. For a description of CTR as well as other modes of encryption, see National Institute of Standards and Technology (NIST) Special Publication 800-38A, “Recommendation for Block Cipher Modes of Operation,” the contents of which are herein incorporated by reference. Note that the CTR-mode implementation is described herein for illustrative purposes only. In general, the invention will work with any cipher mode of operation that transforms a block cipher into a stream cipher, including, but not limited to, CTR (counter) mode, OFB (output feedback) mode, and CFB (cipher feedback), as well as with asymmetric encryption algorithms. Also, the present invention can be implemented with keys comprising any number of bits, and is thus not limited to either 128-bit block size or 128-bit key encryption.

In an embodiment of the invention, the N bits of an arbitrary initialization sequence 11 are appended to the (128 - N) bits of a counter 12 to form a 128-bit input 13 to the encryption algorithm 14. The initialization sequence 11 may be a fixed sequence, whereas the counter 12 has a value that can be incremented each time the encryption algorithm is performed on a 128-bit block of data. A 128-bit private key 15 is also supplied to the encryption algorithm 14. The encryption algorithm 14 may be, for example, the Advanced Encryption Standard (AES) algorithm adopted by the National Institute of Standards and Technology. Note that a 128-bit key is used only to illustrate a specific embodiment of the invention. Other embodiments may employ keys of arbitrary length, for example, 192-bit or 256-bit keys.

From the key 15 and the input 13, the encryption algorithm 14 generates a 128-bit result 16. According to the present invention, the 128-bit result is stored in secondary storage 20. At a later time, the result 16 is retrieved from the secondary storage 20 and XOR'ed bit-by-bit with a 128-bit block of plaintext 17 using the XOR operation 19. The result of the XOR operation is known as ciphertext 18, and is the encrypted version of the 128-bit block of plaintext. Note that while FIG. 16 shows an embodiment wherein the key length and the block length are both 128 bits, in general they do not have to be the same number of bits. For example, a 256-bit key can be used to encrypt 128-bit blocks of plaintext.

To encrypt multiple plaintext blocks of 128 bits, the algorithm shown in FIG. 16 may be performed multiple times, with the counter value 12 being incremented for each plaintext block to be encrypted. Incrementing the counter assigns each successive 128-bit plaintext block a distinct counter value 12, thereby also generating a distinct 128-bit stored result 21 to be XOR'ed with each successive block of plaintext.

Because the successive computations of results 16 do not depend on the content of the successive plaintext blocks 17, the algorithm up to the stored results 21 can be precomputed independently of the plaintext blocks 17 for an arbitrary number of blocks, and stored in secondary storage 20. The computations can thus be cleanly divided into two phases: Phase I and Phase II, with the operation just described up to placing the stored result in secondary storage 20 performed in Phase I, and the subsequent operation to yield ciphertext 18 performed in Phase II.

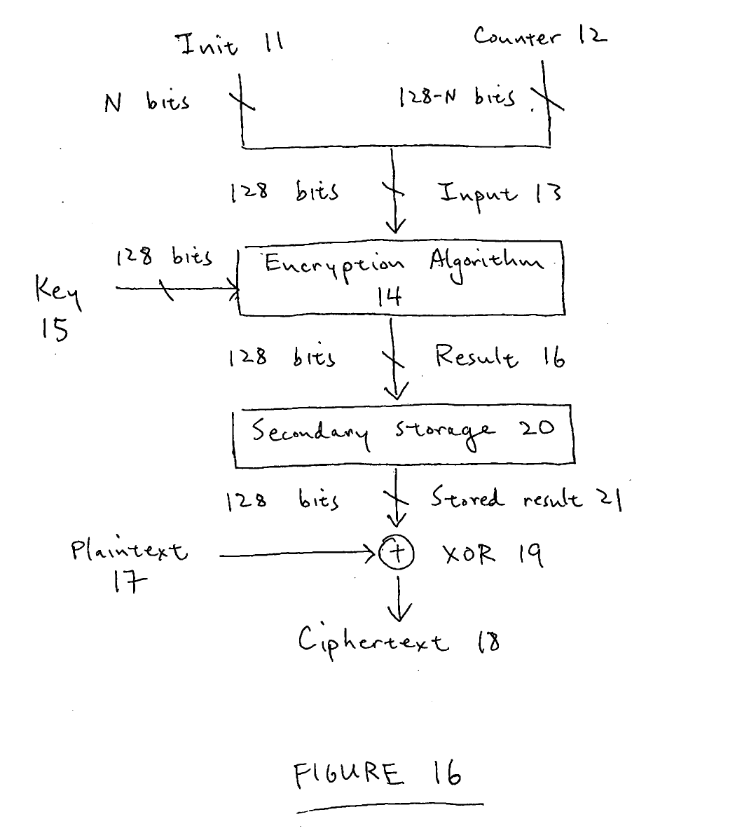

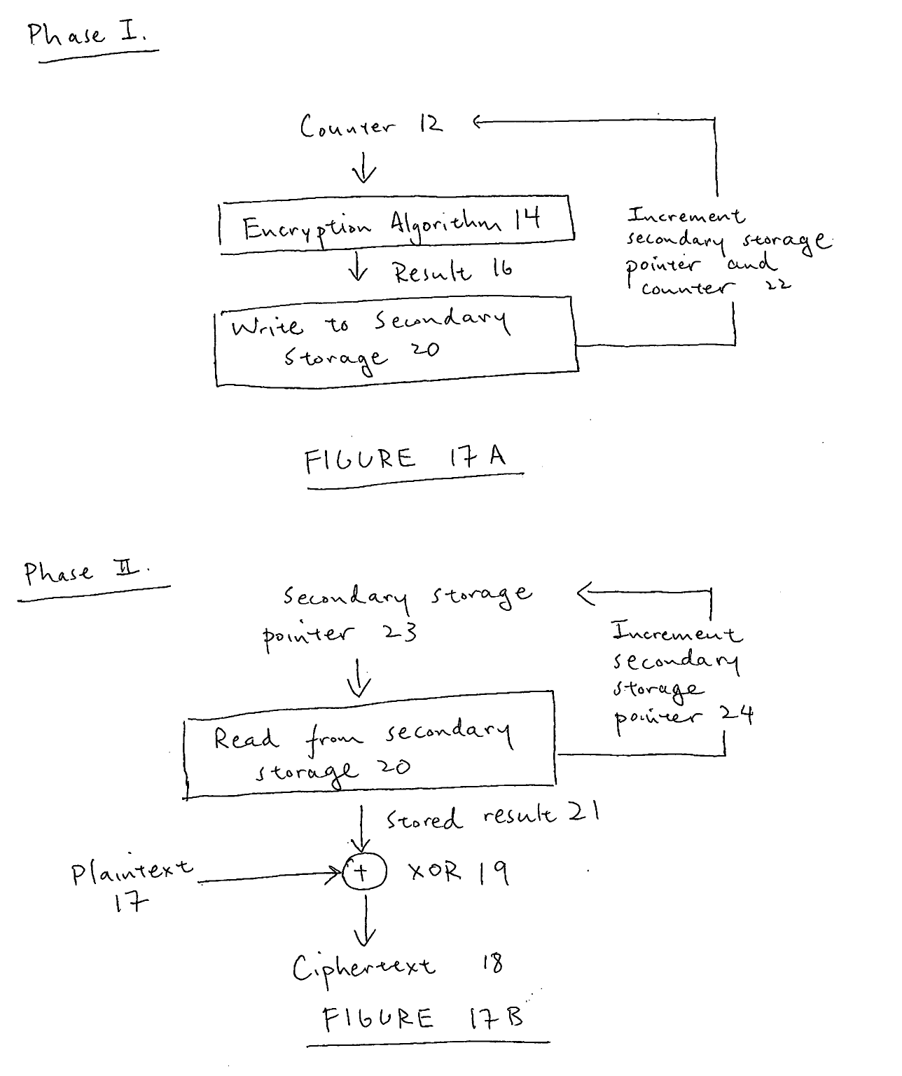

FIG. 17A illustrates the operations that can be performed in Phase I. As in FIG. 16, the value of a counter is input to an encryption algorithm. (Note that the other inputs to the encryption algorithm, including the initialization value and the private key are not shown in FIG. 17A, as they can remain constant throughout Phase I.) The computations for the encryption algorithm 14 are performed, and the result 16 is written to a location in the secondary storage addressed by a secondary storage pointer. After the result is written, the secondary storage pointer is incremented, as shown in 22. The counter 12 is also incremented. The operations are then repeated, with successive results 16 being written to successive locations in memory. After a certain number of results have been written, Phase II is ready to commence. Note that the number of results written to memory in Phase I depends on several factors, including how long the device remains connected to a charger, how much the memory can store, and how much data is later to be encrypted.

FIG. 17B illustrates the operations that are performed in Phase II. First, the secondary storage pointer 23 addresses the location of the first result in memory written during Phase I. The stored result 21 at that location is read from memory, and the value is XOR'ed bit-by-bit with a first block of plaintext 17 to produce a first block of ciphertext 18. Then, the secondary storage pointer is incremented, and the next stored result is read from memory. The operations are repeated for each block of plaintext 17, thus continuously generating blocks of ciphertext 18. In this way, the only computations performed during Phase II are memory reads and XOR operations. This substantially lessens the computational burden on the processor during Phase II.

Note that the embodiment described in FIG. 16 can also be used in a decryption system. In a decryption system, the plaintext 16 in FIG. 16 is replaced by ciphertext, and the ciphertext 18 is replaced by plaintext. In other words, when ciphertext is XOR'ed with the stored result 21, the plaintext is generated.

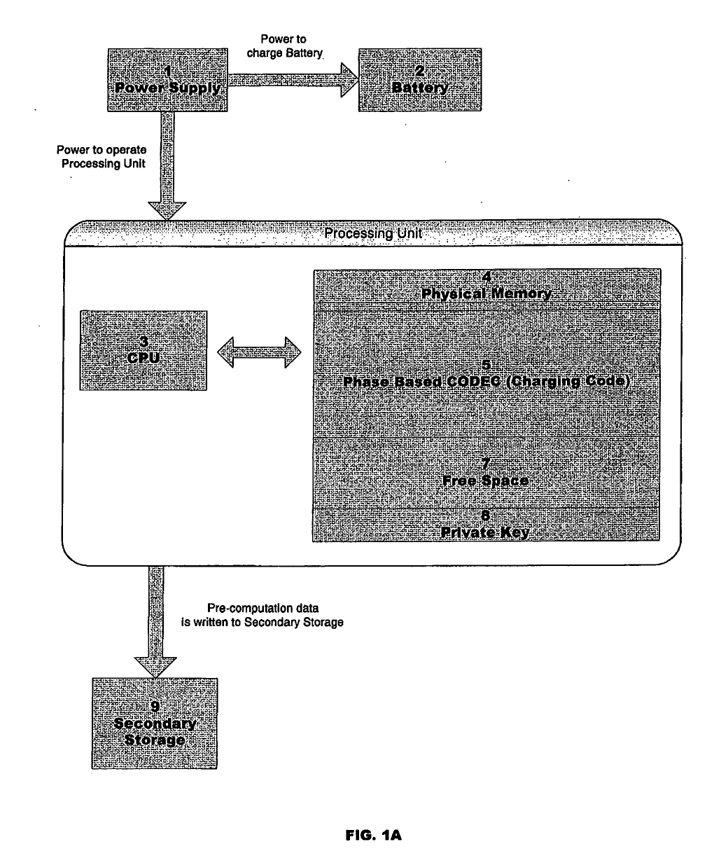

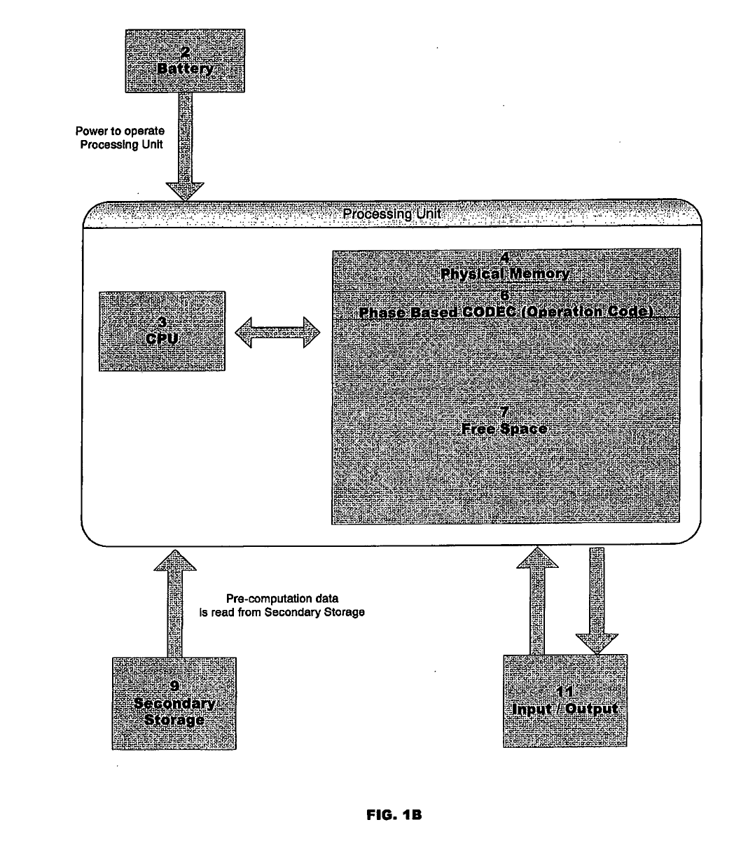

FIGS. 1A and 1B further show how Phase I and Phase II can be divided according to an embodiment of the present invention in a mobile device. FIG.1A shows Phase I, during which the apparatus is connected to a charger. During this phase, power supply 1 is charging battery 2 and powering the processing unit simultaneously. Battery 2 has a quantifiable charging period defined by the physical properties of Battery 2 and the processing unit is able to operate for that time period. Power is supplied to the CPU 3, Physical Memory 4, and Secondary Storage 9. During this time period the apparatus operates a standard symmetric cryptography algorithm in keyed stream mode, as described in conjunction with FIG. 16, and stores the result in Secondary Storage 9. The code for the symmetric algorithm 5 and the Private Key 8 are stored and accessed in Physical Memory 4.

FIG.1B shows the apparatus in Phase II, or operating phase. Battery 2 is supplying power to the Processing Unit. Power is supplied to the CPU 3, Physical Memory 4, and Secondary Storage 9. CPU 3 is able to encrypt and decrypt data by reading pre-computation data from Secondary Storage 9 and XOR'ing it with a plaintext or cipher text stream, as previously described in FIG. 16. There is no resident symmetric cryptography code 5 or Private Key 8 in Physical Memory 4, since all the operations requiring that information have already been performed in Phase I.

From the above description of the preferred embodiments, it can be seen that Phase I uses power from the charger to pre-compute results that are written to secondary storage. While the unit is charging, a secondary storage device such as a hard drive or flash memory drive is written with the pre-computation results. In this manner the processor performs the majority of the computation involved in the algorithm while being connected to a power source.

In contrast, phase 2 performs only relatively simple computations. When operating on battery power, data is combined with the retrieved results using a simple XOR instruction. Typically, a 32-bit microprocessor can perform an XOR operation on 4 bytes in 1 clock cycle. In one embodiment, a 16-byte block can be encrypted or decrypted using the apparatus by executing 1 clock cycle to retrieve the stored results, and 4 clock cycles for the XOR operation, thus requiring only 5 clock cycles during battery-powered operation to encrypt a 128-bit data block. In contrast, as noted earlier, typical conventional algorithms operating on battery power would require 320 clock cycles to encrypt a same-size data block using AES, 668 clock cycles using DES, and 1728 clock cycles using Triple-DES. Note the numbers of clock cycles cited here are merely to illustrate the potential benefits of the invention, and are not meant to limit the invention. Other processor configurations may require fewer or more clock cycles.

As an example of the operations performed, Appendix A of this patent application provides psuedocode for an implementation of Phase I and Phase II according to an embodiment of the present invention. Appendix B provides source code in C-language for an implementation of Phase I and Phase II according to an embodiment of the present invention. These examples are intended only to serve as illustrations of embodiments of the present invention, and are not meant to limit the scope of the present invention.

Since the invention executes fewer cycles during Phase II, it also consumes less precious battery power. The use of secondary storage in the apparatus draws a minimal amount of power, especially, with the use of FLASH memory technology.

Note the throughput of the invention is directly related to the transfer rate of the secondary storage. With present-day storage system technology having sustained transfer rates of up to 100 MB/Sec, the apparatus can accelerate conventional symmetric algorithms by up to 80 times their normal operational speed.

The apparatus can be configured depending on the data communication needs as well as the amount of available storage. For example, if the device does not remain on a charger long enough to perform and save pre-computations for all the data to be encrypted or decrypted, the device can always switch to a conventional mode of operation during Phase II once the stored pre-computation results have been exhausted. This can be accomplished by providing software code on the apparatus that notes how many pre-computation results have been stored in memory during Phase I, detecting when the results have been exhausted in Phase II, and switching the apparatus to conventional operation thereafter. The same applies if there is not enough memory available to store all the pre-computation results corresponding to a large number of plaintext blocks.

To further minimize the power consumption, one can buffer the data and switch the secondary storage device into an idle, or low-power, state. Specifically, some number of pre-computed results from the secondary storage device can be first transferred to an arbitrarily sized RAM buffer, whereupon the storage device can enter low power states when not being used. This saves power because operating a RAM buffer consumes less power than operating a secondary storage device. Note the rate at which the key stream is buffered by the apparatus is variable, and can be adjusted based on the amount of physical memory.

Note that when the apparatus is capturing data (such as real time video) and storing it to memory, then little additional power is required to implement the present invention. This is because the memory needs to be powered on anyway for the data to be recorded to memory, and thus there is no overhead power expended in keeping the memory on for retrieving the stored results. Furthermore, the same secondary storage that stores the results of pre-computations can be used to store the captured data. This is because, once a stored result has been retrieved from secondary storage and used to encrypt the captured data, then the captured data can be written to secondary storage at the location occupied by the stored result already retrieved. Thus in this configuration, no extra memory is required.

Note also that the software code required for the encryption algorithm is only used during Phase I, so that it can be stored in secondary storage the rest of the time. Since there is no need to load the software code for encryption into physical memory during Phase II, the invention can operate during Phase II using just a few bytes of software code in physical memory, namely, the software code required to implement the XOR operation. Standard symmetric algorithms have a predefined physical memory requirement of 50 to 100 times this size.

Another advantage of the present invention is that, like the encryption code, the private key need not be loaded into physical memory during Phase II. Since all computations using the key are performed during Phase I, the key can be discarded after the completion of Phase I. Thus if the memory contents of the device were somehow breached when the device is operating in Phase II, the intruder would not have direct access to the private key. Rather, the only way to ascertain the private key would be to examine the stored results in the secondary storage, and this task is tantamount to breaking the encryption algorithm. This makes the present invention inherently secure, as it is based entirely on the security of whatever encryption algorithm is used to generate the key stream. For additional security, a new private key can be used every time the device re-enters Phase I.

Note that Phase I and Phase II need not be restricted to the times when a device is charging and operating from a battery, respectively. The invention can be applied whenever computational or power resources are known to be more abundant during one time period than during another. For example, software code may detect when a processor is relatively idle, for example by examining when the processor is consuming a small portion of its computational bandwidth, and initiate the execution of the Phase I operations during that period. The results can be stored for later retrieval during Phase II, when processor resources are less abundant. Thus, rather than saving power, the invention would allow the processor to run faster during Phase II.

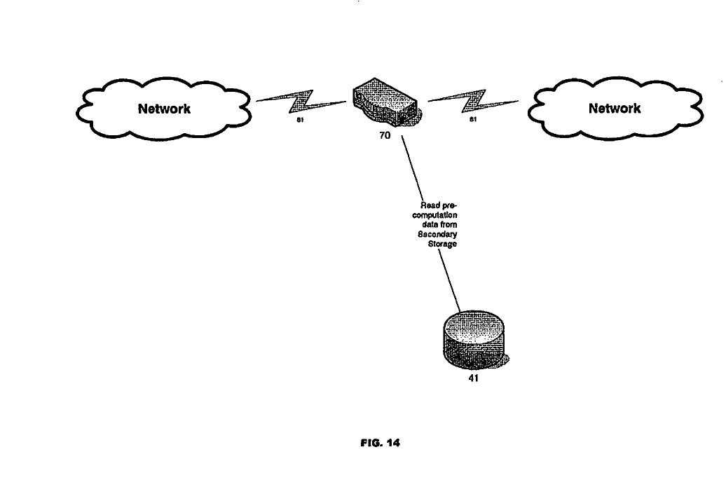

Furthermore, note that Phase I and Phase II need not be mutually exclusive in time. In one embodiment of the invention, a stand-alone or dedicated processor can be dedicated to continually performing Phase I operations, and save the results of those operations to secondary storage. Meanwhile, another system component with more limited power or computational resources can be continuously or intermittently operating in Phase II, by retrieving the results saved to secondary storage by the dedicated processor. FIG. 14A describes an embodiment in a high-speed router that utilizes this aspect of the invention.

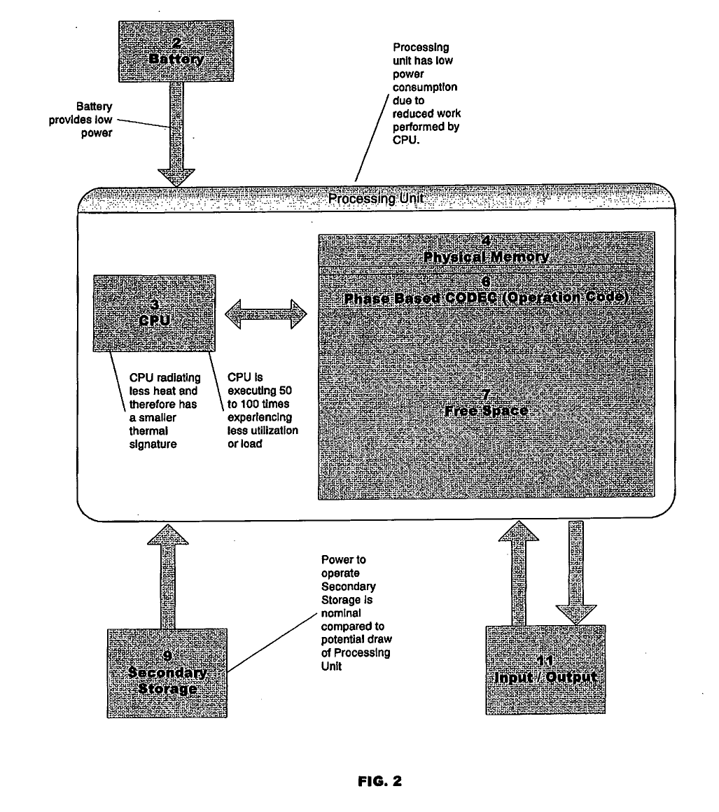

Further illustrations of the preferred embodiment and the associated advantages will be described herein. FIG. 2 shows the apparatus in operating phase (Phase II) and the method of reduced power consumption. Battery 2 is supplying low power to the Processing Unit. Power is supplied to the CPU 3, Physical Memory 4, and Secondary Storage 9. CPU 3 is able to encrypt and decrypt data by reading pre-computation data from Secondary Storage 9 and executing 64 to 345 times fewer clock cycles. The result of this is a reduction in processor utilization, power consumption, and size of thermal signature.

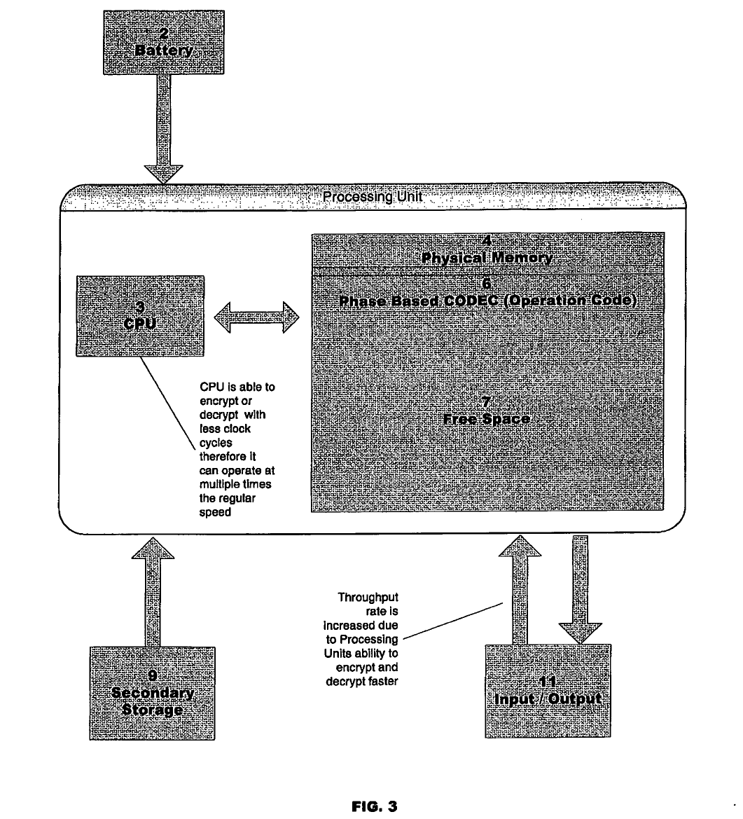

FIG. 3 shows the apparatus in operating phase (Phase II) and demonstrating the method of acceleration of data throughput rate. Battery 2 is supplying high power to the Processing Unit. Power is supplied to the CPU 3, Physical Memory 4, and Secondary Storage 9. CPU 3 is able to encrypt and decrypt data at a higher throughput by reading pre-computation data from Secondary Storage 9 and using 50 to 100 times less clock cycles during Phase II to encode the same amount of data, therefore achieving a higher throughput rate.

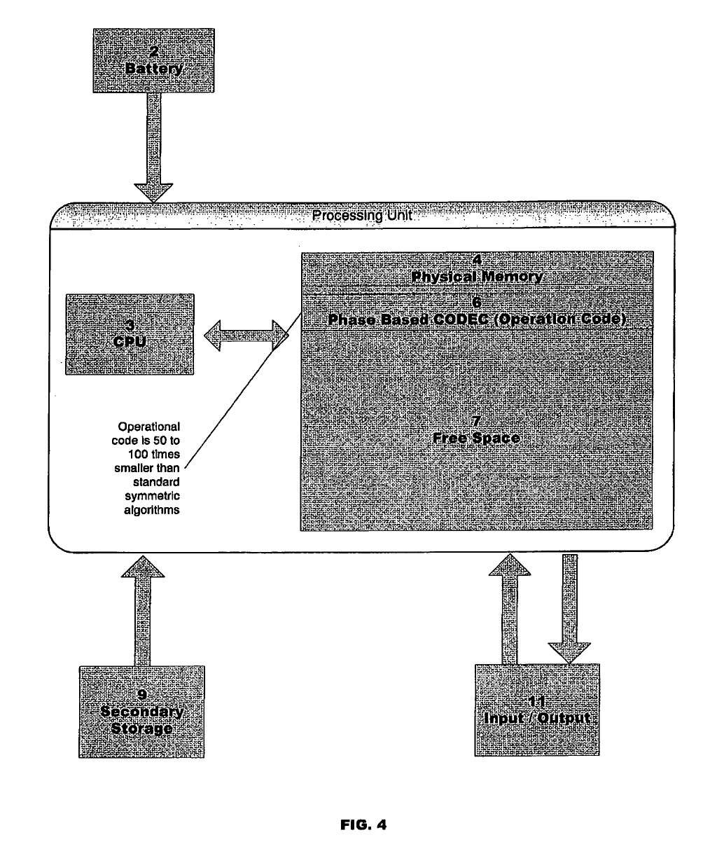

FIG. 4 shows the apparatus in operating phase (Phase II) and demonstrates the method of reduced memory requirements. Physical Memory 4 contains resident code that can be as small as a few bytes due to the fact that it is just executing XOR instructions in a loop.

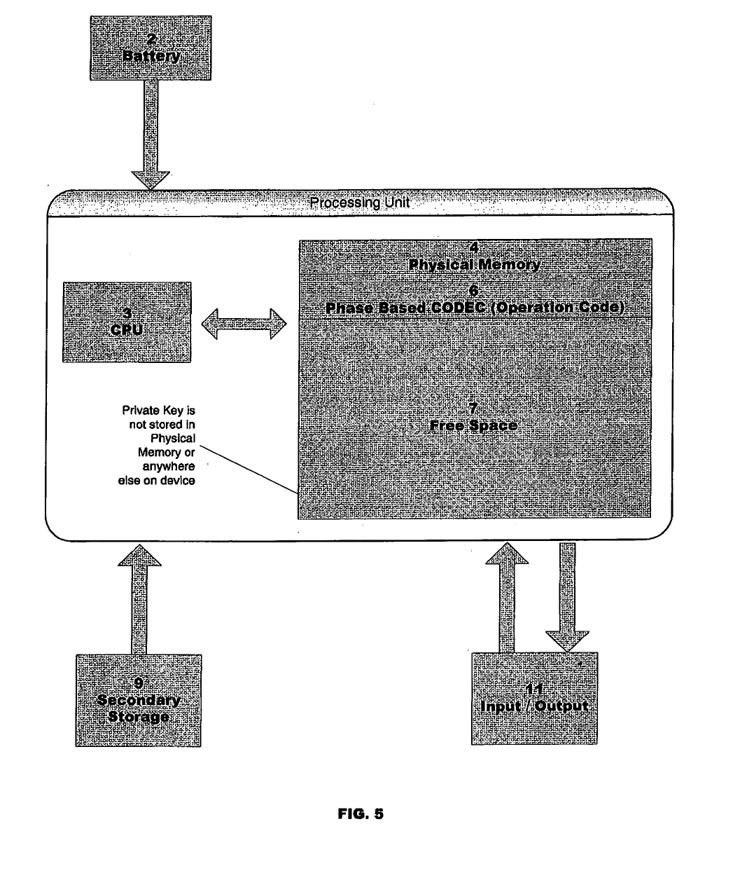

FIG. 5 shows the apparatus in operating phase (Phase II) and demonstrates the method of not storing private key. There is no Private Key 8 in Physical Memory 4 because the Private Key 8 is not necessary for the computations performed in Phase II.

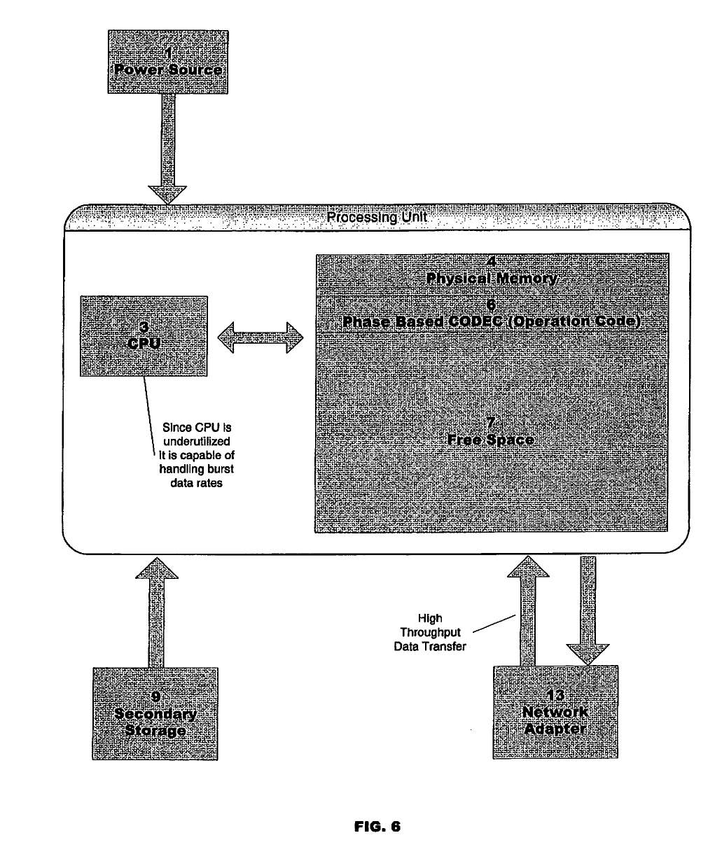

FIG. 6 shows the apparatus in operating phase (Phase II) and demonstrates the method of handling data burst rates. Since CPU 3 is underutilized it is capable of handling burst data rates. The maximum data rate is determined by the maximum data rate of Secondary Storage 9.

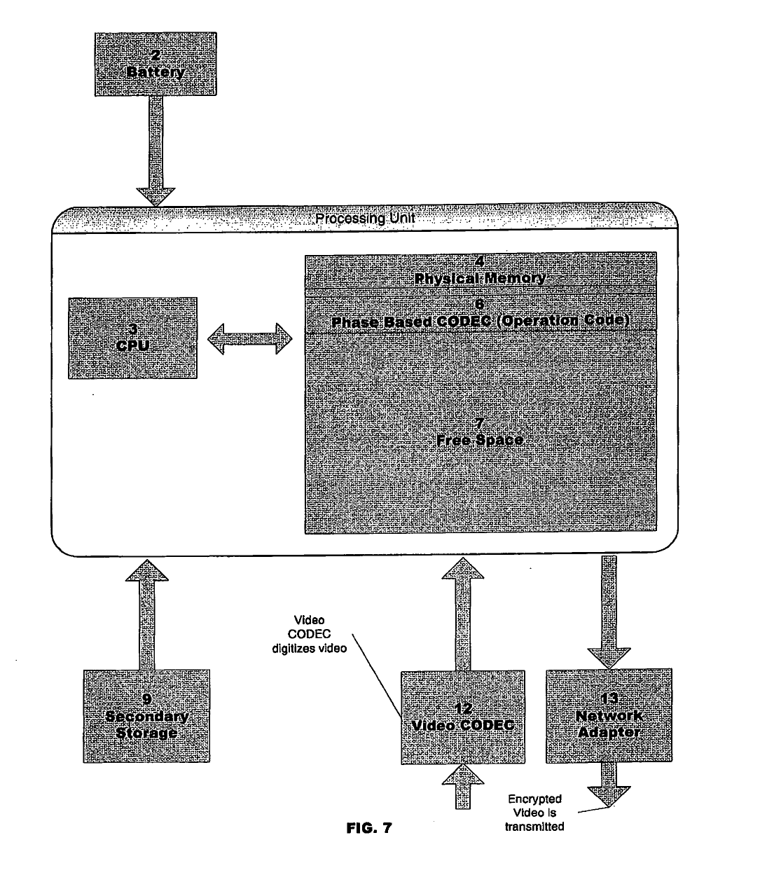

FIG. 7 shows the apparatus in operating phase (Phase II) and demonstrates the method of video transmission over wireless. Here Video CODEC 12 captures video, the Processing Unit encrypts the digital data, and it is transmitted from Network Adapter 13.

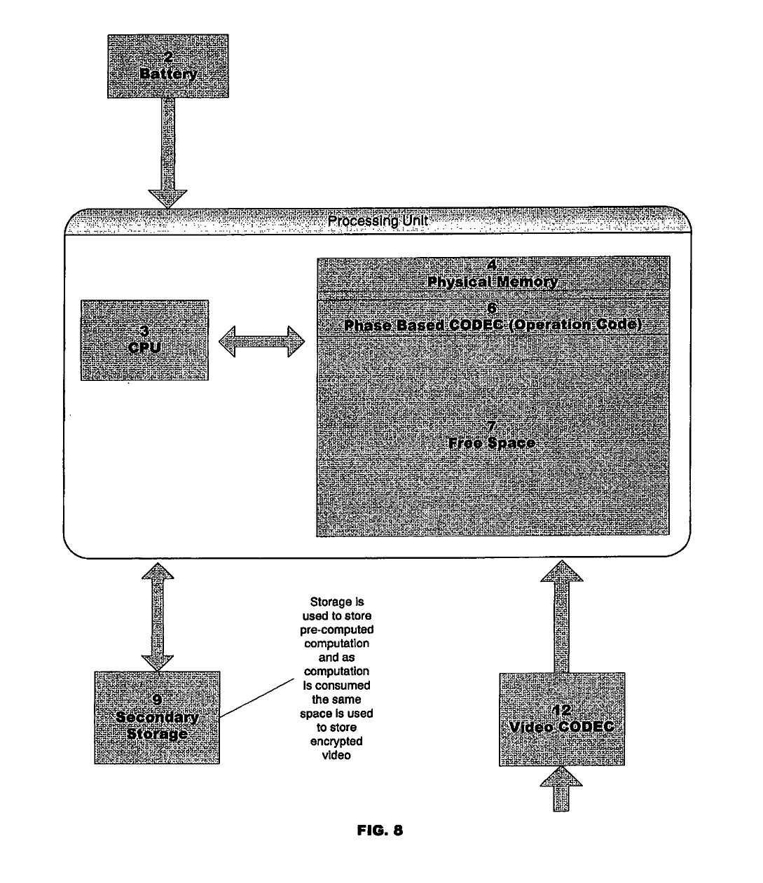

FIG. 8 shows the apparatus in operating phase (Phase II) and demonstrates the method of video recording. Here Video CODEC 12 captures video, the Processing Unit encrypts the digital data, and it is recorded to Secondary Storage 9. Here the same secondary storage device can be used to both store the pre-computation data, and the encrypted video, due to the fact that once the pre-computation data is read, it can be replaced with the video data.

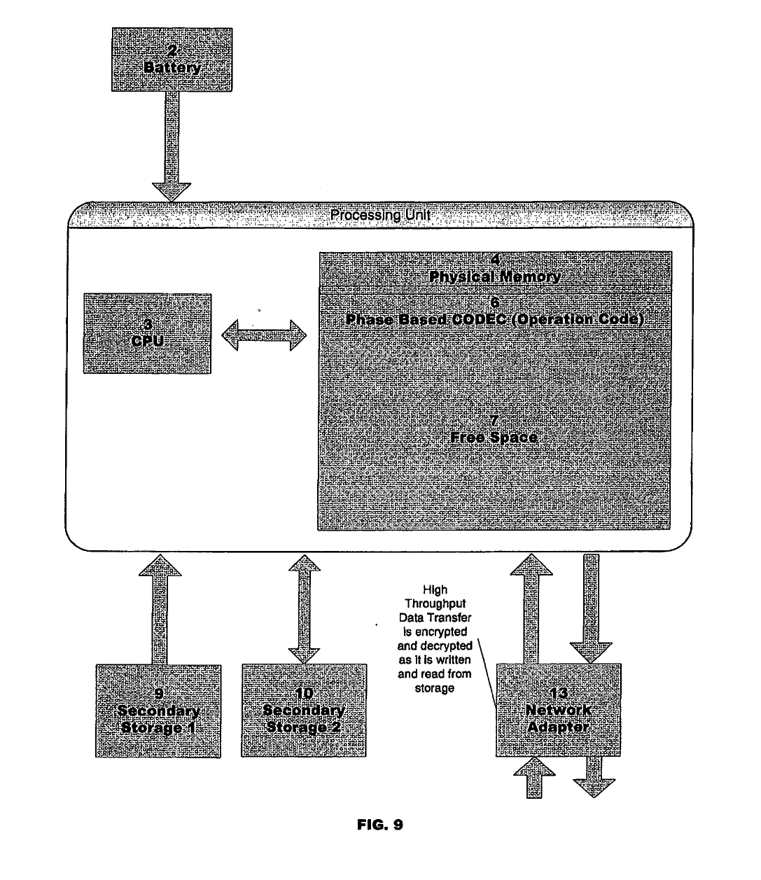

FIG. 9 shows the apparatus in operating phase (Phase II) and demonstrates the method of a mobile video data server. Here data can be read or written over Network Adapter 13 and use minimal power or achieve a higher throughput rate than would normally be possible.

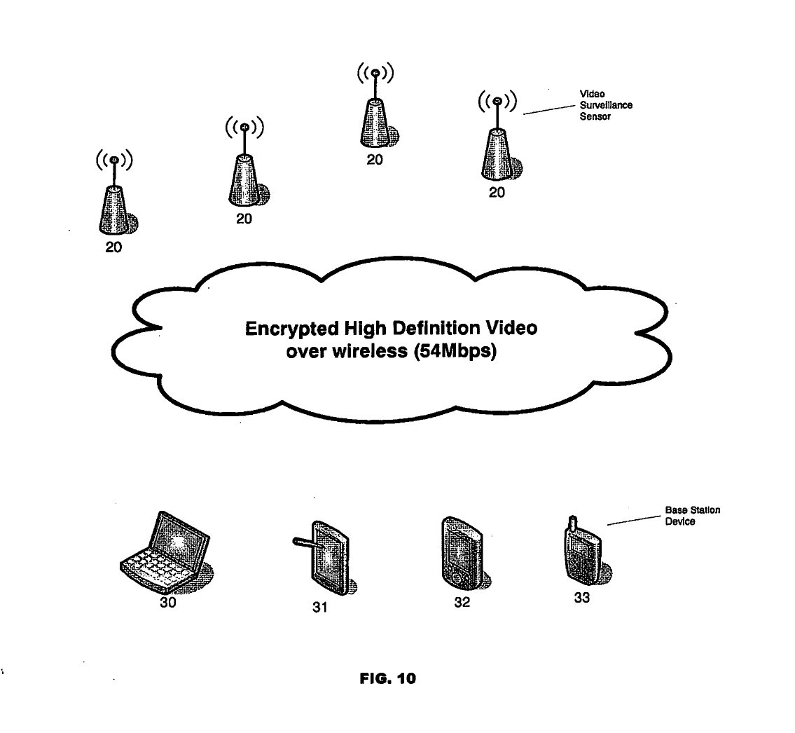

FIG. 10 shows the apparatus being used in a sensor network configuration. Each Video Surveillance Sensor 20 transmits encrypted video to one or more Base Station Devices (30, 31, 32, 33). These devices range from notebook computers down to handhelds. High definition video is possible due to 54 Mbps bandwidth over wireless.

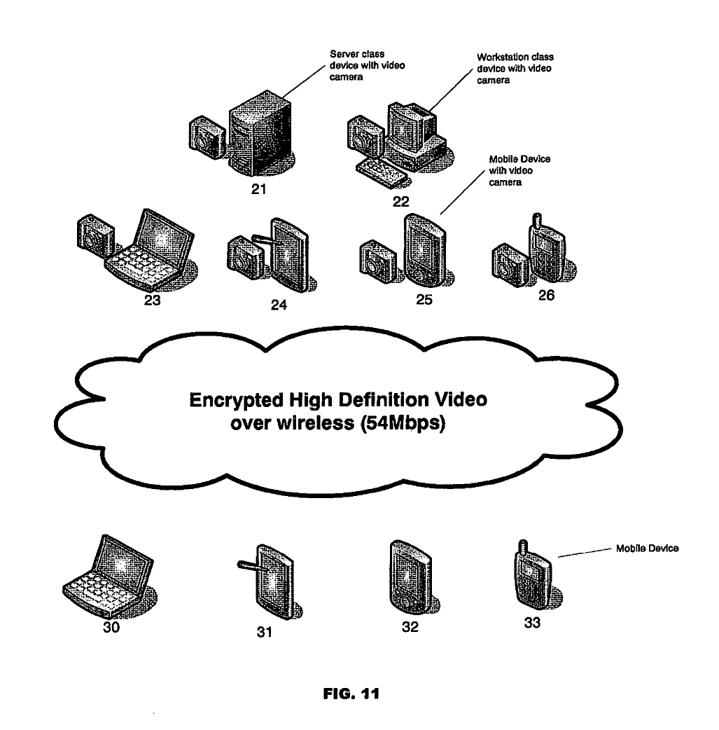

FIG. 11 shows the apparatus being used in a mobile network configuration. Each device capable of capturing video (21, 22, 23, 24, 25, 26) transmits encrypted video to one or more Mobile Devices (30, 31, 32, 33). High definition video is possible due to 54 Mbps bandwidth over wireless.

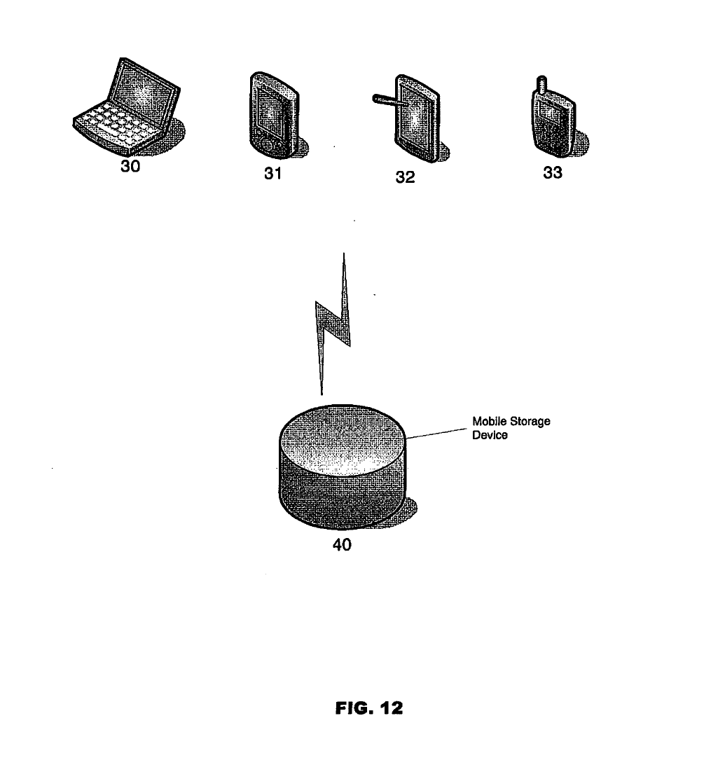

FIG. 12 shows the apparatus being used in a mobile storage configuration. Each Mobile Device (30, 31, 32, 33) is capable of downloading data to the Mobile Storage Device 40. Here the Mobile Storage Device 40 is able to operate at a low level of power consumption due to the invention.

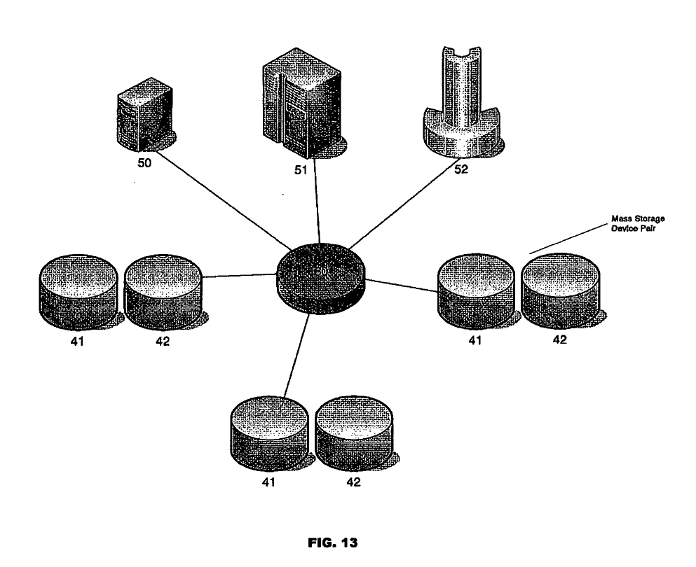

FIG. 13 shows the apparatus being used in a high-end server configuration. Each High-end Server Device (50, 51, 52) is capable of writing data to the Mobile Storage Device Pairs 41 and 42. Data burst rates (higher than possible with standard symmetric cryptography) as well as potentially lower power consumption are possible due to the invention.

FIG. 14 shows the apparatus being used in a high-speed router configuration. The high-speed router 70 sends, and receives, data over high-speed network links 61. The router uses pre-computed data in secondary storage 41 (which is calculated during idle time) to handle data burst rates and reduce processor utilization during Phase II.

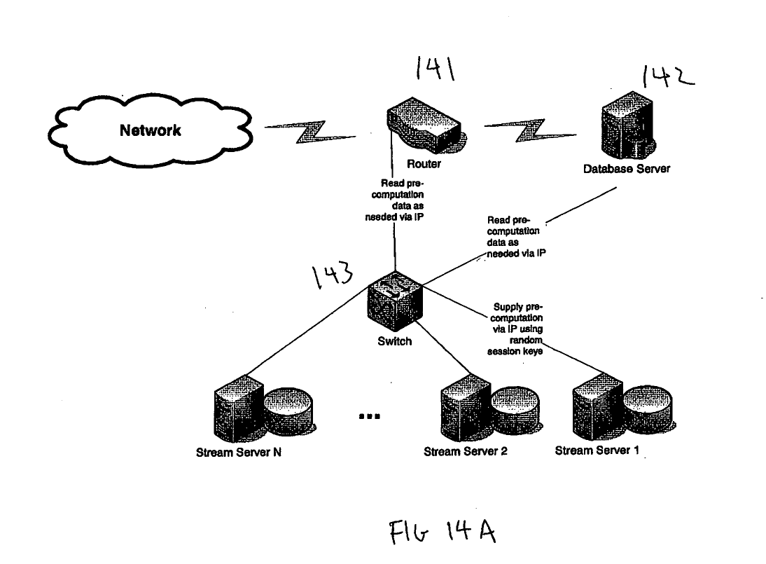

FIG. 15 shows the apparatus being used in a high-end server configuration to support logging of massive amounts of data. The high-end server 50 processes data over high-speed network links 61. The server uses pre-computed data in secondary storage 42 (which is calculated during idle time) to enable high-speed logging in secondary storage 41 and reduce processor utilization during Phase II.

Reference will now be made in detail to various applications of the invention, examples of which are illustrated in the accompanying drawings. The applications disclosed are for illustrative purposes only, and are not meant to restrict the scope of the present invention. Embodiments in accordance with the present invention are relevant to all types of data.

One application of the invention is to a sensor network (FIG. 10). In this configuration many small sensors capture digital video and transmit back to one or more base stations. These base stations range in size, and power, from notebooks to handheld devices.

Another application of the invention is to a mobile network (FIG. 11). In this configuration, one or more mobile devices capture digital video and transmit encrypted video to one, or more, other mobile device or a mobile data server (FIG. 12). These computers range in size and power from notebooks to handheld devices.

Another application of the invention is to a video recorder or player. (FIG. 8). In this configuration the invention can be used to encrypt and decrypt video written or read from storage.

Yet another application of the invention is to a mobile data server (FIG. 12). In this configuration one or more mobile devices connect to a mobile data storage unit and upload or download digital video at a high throughput rate.

Another application of the invention is to a high-end server (FIG. 13). In this configuration the invention can be used to increase throughput rates in order to handle burst data. It can also be used to provide high-speed encryption for logging allowing the server to log everything (FIG. 15).

Another application of the invention is to a high-speed router (FIG. 14). In this configuration the invention can be used to increase throughput rates in order to handle burst data traffic. It can also be used to provide high-speed encryption for logging allowing the router to log everything.

FIG. 14A shows an application of the invention to a high-speed router. In this embodiment, Stream Servers 1 through N compute the Phase I operations, and save the results to secondary storage (not shown). Meanwhile, the router 141 and the database server 142 perform the Phase II operations by retrieving the saved results from secondary storage as needed. For easy access, the results can be retrieved from secondary storage using the Internet Protocol (IP) via a switch 143.

While certain embodiments have been described above, other embodiments will be obvious in view of the above description to those skilled in the art. For example, the invention will work with encryption methods such as AES, DES, or Triple-DES, in which a block cipher can be transformed into a stream cipher in certain modes of operation such as CTR (counter) mode, OFB (output feedback) mode, and CFB (cipher feedback) mode. The invention will also apply to asymmetric encryption algorithms. Also, the present invention can be implemented with keys or blocks comprising any number of bits. Therefore, it should be understood that the invention can be practiced with modification and alteration within the spirit and scope of the appended claims. The description above is not intended to be exhaustive or to limit the invention to the precise form disclosed. It should be understood that the invention can be practiced with modification and alteration and that the invention be limited only by the claims and the equivalents thereof.

What is claimed is:

1. A method for encrypting or decrypting data comprising:
during a first phase, generating a result based on inputs comprising a key and a first input, and storing the result in a memory; and
during a second phase, retrieving the result stored in memory, and generating an output based on inputs comprising the retrieved result and a data block.

2. The method of claim 1, wherein the steps of the first phase are executed prior to the second phase.

3. The method of claim 1, wherein the steps of the first phase are executed concurrently with the second phase.

4. The method of claim 1, wherein generating a result based on inputs comprises encrypting the first input using the key.

5. The method of claim 4, wherein:
the key is a private key;
the data block is a plaintext block; and
the output is a ciphertext block.

6. The method of claim 5, wherein encrypting the first input comprises encrypting the first input using a symmetric cryptography algorithm.

7. The method of claim 4, wherein encrypting the first input comprises encrypting the first input using the Advanced Encryption Standard.

8. The method of claim 4, wherein encrypting the first input comprises encrypting the first input using the Data Encryption Standard.

9. The method of claim 4, wherein encrypting the first input comprises encrypting the first input using the Triple Data Encryption Standard.

10. The method of claim 1, wherein generating an output comprises performing an XOR operation between the bits of the result and the bits of the data block.

11. The method of claim 4, wherein the first input comprises an initialization value and a counter value.

12. A method for encrypting or decrypting data comprising:
dividing the data into data blocks;
applying the method of claim 11 to each data block;
wherein the counter value is varied for each data block.

13. The method of claim 12, wherein the counter value is incremented for each data block.

14. The method of claim 1, wherein retrieving the result stored in memory comprises loading the result stored in memory into a memory buffer, and retrieving the result from the memory buffer.

15. An apparatus for encrypting or decrypting data comprising:
an algorithm for, during a first phase, generating a result based on inputs comprising a key and a first input; and
a memory for, during the first phase, storing the result generated during the first phase;
wherein the result stored during the first phase can be retrieved during a second phase.

16. The apparatus of claim 15, wherein the input comprises an initialization value and a counter value.

17. The apparatus of claim 15, wherein an output is generated based on a data block and the result retrieved during the second phase.

18. The apparatus of claim 15, further comprising a battery for supplying power to the apparatus, wherein the first phase comprises a period of time when the battery is being recharged.

19. The apparatus of claim 15, wherein the second phase comprises a period of time when the battery supplies power to the apparatus.

20. The apparatus of claim 15, wherein the algorithm comprises an encryption algorithm according to the Advanced Encryption Standard.

21. The apparatus of claim 20, wherein the algorithm is executed in counter (CTR) mode.

22. The apparatus of claim 20, wherein the algorithm is executed in output feedback (OFB) mode.

23. The apparatus of claim 15, further comprising a sensor for sensing a first period of time during which the apparatus has more computational resources than during a second period of time.

24. The apparatus of claim 23, wherein the apparatus operates in the first phase in response to the sensor sensing the first period.

25. The apparatus of claim 23, wherein the apparatus operates in the second phase in response to the sensor sensing the second period.

26. The apparatus of claim 23, wherein the computational resources comprise electrical power.

27. The apparatus of claim 23, wherein the computational resources comprise computational bandwidth.

28. An apparatus for encrypting or decrypting data comprising:
an algorithm for, during a first phase, generating a result based on inputs comprising a key and a first input; and
a memory for, during the first phase, storing the result generated during the first phase; and
a means for retrieving during a second phase the result stored during the first phase.
